(19) United States
(12) Patent Application Publication
(10) Pub. No.: US 2018/0268799 A1
(43) Pub. Date: Sep. 20, 2018

(54) METHODS AND APPARATUS FOR AN ACOUSTIC DAMPENING PANEL

(71) Applicant: FABRICATION SPECIALTIES, INC., Bridgeview, IL (US)

(72) Inventor: Matt Calmeyn, Bridgeview, IL (US)

(21) Appl. No.: 15/460,356

(22) Filed: Mar. 16, 2017

(51) Int. Cl. G10K 11/168; F16M 13/02; A47G 1/20

(52) U.S. Cl. CPC G10K 11/168; A47G 1/20; F16M 13/02

(57) ABSTRACT

An acoustic panel comprises an acoustically opaque fiberglass insulation board with a front side and a rear side. A wooden laminate frame is affixed to the rear side of the fiberglass insulation board by laminating. The frame is comprising a first bar, a second bar substantially parallel to the first bar, and a third and fourth bar, each connecting the first bar to the second bar. The panel also includes an acoustically transparent fabric wrapped around the front side of the wood frame.

### FIELD OF THE DISCLOSURE

The present description relates generally to acoustic panels for management and mitigation of sound.

### BACKGROUND OF RELATED ART

Sound absorbing materials are used in a variety of environments to manage sounds. In some situations, acoustic materials are included into the architecture of a venue to direct and focus sounds where they are needed. In other cases, the acoustic materials are used to minimize and deaden the progression of sound through a space. In many cases, the acoustic needs of the space are not known upon construction of the space.

Existing acoustic management systems are difficult to transport or install. Most require that the space be designed and constructed with the eventual acoustics in mind. If the system is being added to an existing space, an expensive and extensive remodeling is usually needed to rebuild surfaces and replace materials. As acoustically absorbing materials are generally fragile, they cannot usually be easily transported and positioned by a general consumer, thus requiring experts and the aforementioned installation process.

### SUMMARY

An acoustic panel comprises an acoustically opaque insulation board with a front side and a rear side. A frame is affixed to the rear side of the insulation board. The frame is made of a first bar, a second bar substantially parallel to the first bar, and a third and fourth bar, each connecting the first bar to the second bar. The panel also includes a covering wrapped around the front side of the wood frame.

An acoustic panel comprises an acoustically opaque fiberglass insulation board with a front side and a rear side. A wooden laminate frame is affixed to the rear side of the fiberglass insulation board by laminating. The frame is comprising a first bar with a first end and an second end, a second bar substantially parallel to the first bar, also with a first end and an second end, and a third and fourth bar, connecting the first end of the first bar to the first end of the second bar and also connecting the second end of the first bar and the second end of the second bar. The panel also includes an acoustically transparent fabric wrapped around the front side of the wood frame.

### BRIEF DESCRIPTION OF THE DRAWINGS

FIG. 1 is a perspective view of the example acoustic wall panel.

FIG. 2 is a rear view of the acoustic wall panel of FIG. 1.

FIG. 3 is a cutaway view of the insulation of the acoustic wall panel of FIG. 1.

FIG. 4 is a view of the example acoustic panel installed on a wall.

### DETAILED DESCRIPTION

The following description of example methods and apparatus is not intended to limit the scope of the description to the precise form or forms detailed herein. Instead the following description is intended to be illustrative so that others may follow its teachings.

“Acoustically transparent” materials as used in this specification means that a material is able to transmit sounds through the material with minimal dampening.

“Acoustically opaque” materials as used in this specification means that a material is not able to transmit sounds. Some acoustically opaque materials reflect sound, but others absorb sound working as a dampener.

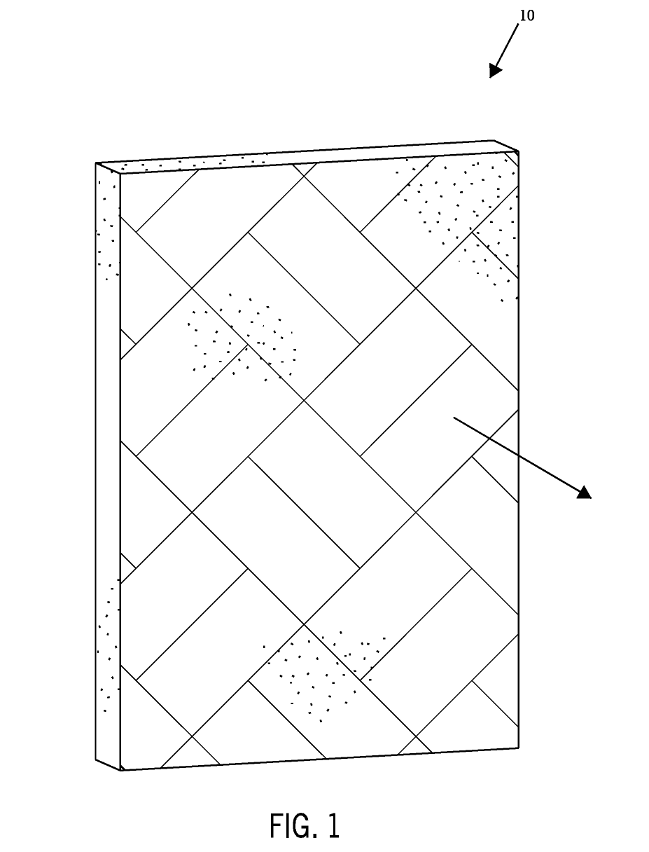

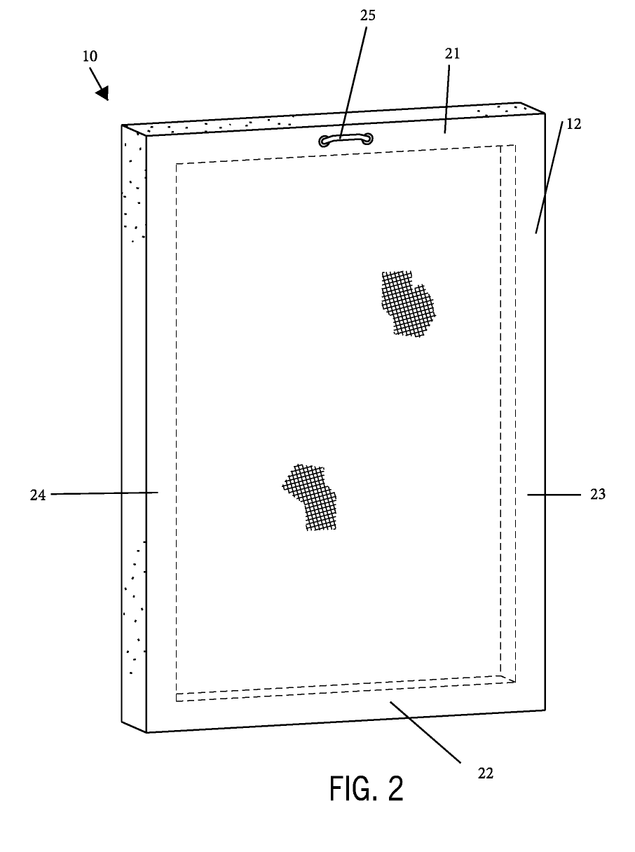

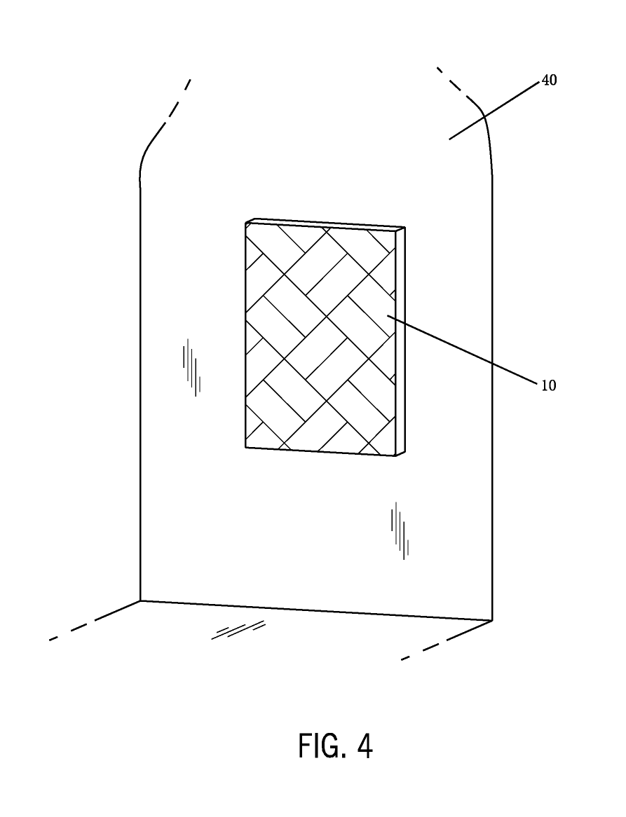

Referring now to FIG. 1, an acoustic panel 10 is shown with its front side visible. A rear view of the panel 10 is shown in FIG. 2. The panel 10 is constructed of a covering 12, a frame 14, and an insulation board 16. To create this panel, the insulation board 16 is built into the frame 14, before both are wrapped in covering 12. This forms an internal cavity 20 within the panel 10 which is advantageous for acoustic control. In use, as described below with regard to FIG. 4, the panel 10 would be placed or hung on a wall 40 using a variety of conventional methods.

Frame 14 is constructed of four frame members: a first bar 21, a second bar 22, a third bar 23, and a fourth bar 24. The first bar 21 is positioned at the top end of the panel 10. Similarly, the second bar 22 is positioned at the bottom end of the panel 10. The first and second bars 21, 22 are generally parallel with respect to each other. The third bar 23 and fourth bar 24, on the right and left sides respectively, are generally perpendicular to connect the first and second bars 21, 22.

Turning to FIG. 2, the frame 14 and each of the first bar 21, second bar 22, third bar 23, and fourth bar 24 are generally made of wood. The bars 21-24 could be made of any low cost structural and easily manufacturable material, for example a plastic such as high density polyethylene (HDPE) or polypropylene or metals such as aluminum. The selected material should aid in the general acoustic absorption of the panel 10. Some materials, even when covered by the covering 12, will be too acoustically reflective to function in the panel 10.

The frame bars 21-24 are joined using a bridle joint (not shown), sometimes called a mortise and tenon. When the smaller tenon is inserted in the gap formed in the mortise, an adhesive is used to secure the joint. The adhesive in the example shown is a conventional carpenter's glue, but could be any adhesive appropriate to the materials and joining technique used. If the frame is made of wood, other conventional wood working joints can be used such as a butt joint, dovetail joint, or finger joint. One of ordinary skill in the art would appreciate that other methods appropriate to the material could be used, for example, tapped holes and screws into a aluminum frame.

Affixed to the frame 12 is an attachment means 25 as shown in FIG. 2. Attachment means 25 serves to connect the panel 10 to a wall or other surface and support it. The attachment means 25 in the example shown is a sawtooth hanger, when placed on a nail inserted into the wall. Depending on the environment in which the user is seeking to install the panel 10, the attachment means 25 can be any suitable means of affixation. These are usually mechanical mounting methods like screws or nails on the wall fitting into hooks or picture wire on the frame 12. Usually a hook would be positioned at the center of the first bar 21 at the top rear of the panel 10. A picture wire would be attached either at the top along first bar 21 or affixed at either end on third bar 23 and fourth 24. It is contemplated that this design can also be used with drywall anchors like wall plug anchors or toggle bolt anchors.

Insulation board 16 is an acoustically opaque material that serves to dampen sound within the internal cavity 20. The insulation board 16 in the example shown is built into the frame 14 as described below and constructed out of fiberglass. The insulation board 16 does not take up the entire internal cavity 20. The air gap in the cavity is used to improve the panels' acoustical performance by acting as an acoustical opaque material, absorbing the sound. While the insulation board 16 in the example shown is made out of fiberglass, it is contemplated that it could be made out of other materials like mineral wool, acoustic foam, polyurethane, or other sound absorbing acoustically opaque materials.

In this example, the frame 14 is laminated onto a premade frame 14. In another example, the frame 14 is laminated directly onto the insulation board 16 using wood strips and forms the bars 21-24 out of those strips, creating a single body. The wooden frame allows us or the end user to apply a picture hanger, hook, or picture wire significantly more easily. The laminated frame creates a strong single piece panel that is more safely transported and moved into place.

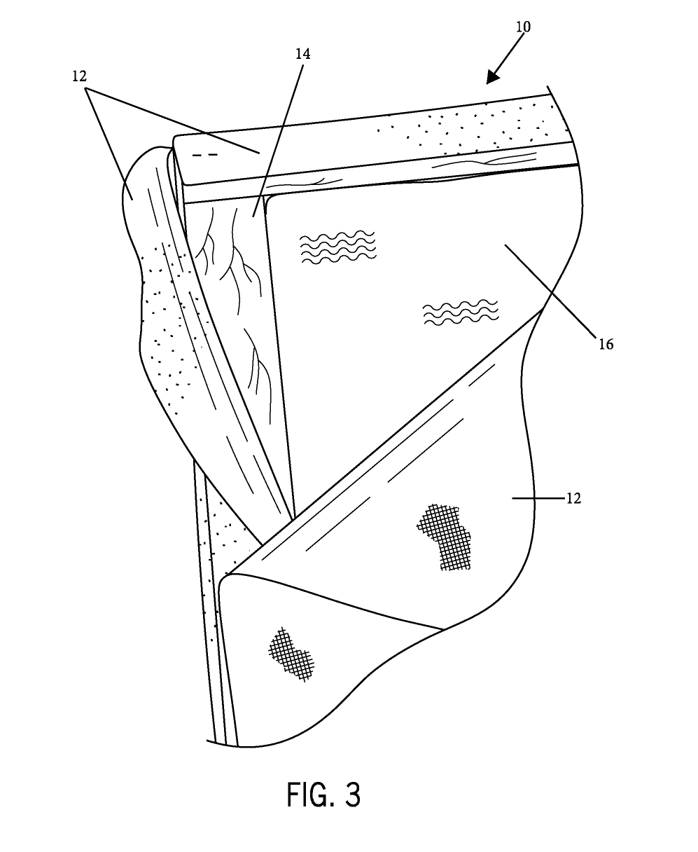

As shown in FIG. 3, the covering 12 is placed around the exterior of the panel 10. The covering 12 is made of acoustically transparent fabric to allow sound to penetrate into the inner cavity 20. It can be decorative as in the example shown. In other examples, the covering may be unadorned or printed. As shown in the cutaway view of FIG. 3, the covering 12 can be made in two parts. In this example, a decorative fabric is placed on the front of the panel 10 and a screen material on the back. It is appreciated that other acoustically transparent materials could be used as the covering 12.

Turning to FIG. 4, which shows a panel 10 installed on a wall 40. The panel works both as aesthetic décor and as a part of a functional acoustic management system. The design disclosed here is substantially easier to install than conventional acoustic control system. Panels with a picture hanger, hook, picture wire or other attachment means 25 are far easier to hang on a wall than a fiberglass panel or conventional acoustic management system.

In this disclosure, the terms “front,” “back,” “top,” “bottom,” “rear,” “left,” and “right” have been used. These are meant to provide context and a sense of relative orientation. They should not be understood to insist on an absolute orientation. The design disclosed here can be oriented in many directions as desired by the consumer.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. An acoustic panel comprising:
an acoustically opaque insulation board with a front side and a rear side;
a frame, affixed to the rear side of the insulation board, comprising
a first bar,
a second bar substantially parallel to the first bar, and
a third and fourth bar, each connecting the first bar to the second bar;
a covering wrapped around the front side of the wood frame.

2. The acoustic panel of claim 1, wherein the insulation board is made of fiberglass.

3. The acoustic panel of claim 1, wherein the insulation board is made of mineral wool.

4. The acoustic panel of claim 1, wherein the frame is made of wood.

5. The acoustic panel of claim 4, wherein the frame is laminated from wood strips.

6. The acoustic panel of claim 1, further comprising an air gap between the rear of the panel and the insulation board.

7. The acoustic panel of claim 1, further comprising a hanging mechanism adapted to affix the acoustic panel to a surface.

8. The acoustic panel of claim 7, wherein the hanging mechanism is a hook.

9. The acoustic panel of claim 7, wherein the hanging mechanism is a picture wire.

10. The acoustic panel of claim 1, wherein the covering is an acoustically transparent fabric.

11. An acoustic panel comprising:
an acoustically opaque fiberglass insulation board with a front side and a rear side;
a wooden laminate frame, affixed to the rear side of the fiberglass insulation board by laminating, comprising
a first bar with a first end and an second end,
a second bar substantially parallel to the first bar, also with a first end and an second end, and
a third and fourth bar, connecting the first end of the first bar to the first end of the second bar and also connecting the second end of the first bar and the second end of the second bar;
an acoustically transparent fabric wrapped around the front side of the wood frame.
